(19) United States
(12) Patent Application Publication
(10) Pub. No.: US 2025/0030657 A1
(43) Pub. Date: Jan. 23, 2025

(54) SYSTEMS AND METHODS FOR INTERNET PROTOCOL ADDRESS RESOLUTION VIA CONTROL PLANE

(71) Applicant: Cisco Technology, Inc., San Jose, CA (US)

(72) Inventors: Patrice Brissette, Gatineau (CA); Jiri Chaloupka, San Jose, CA (US); Andy Karch, Santa Clara, CA (US)

(21) Appl. No.: 18/355,074

(22) Filed: Jul. 19, 2023

Related U.S. Application Data
(60) Provisional application No. 63/379,424, filed on Oct. 13, 2022.

(51) Int. Cl. H04L 61/103

(52) U.S. Cl. CPC H04L 61/103

(57) ABSTRACT

Systems, methods and computer-readable storage media are provided for performing Internet Protocol (IP) address resolution within a network through a control plane or network controller approach. A provider edge (PE) device receives an Address Resolution Protocol (ARP) request message from a locally connected customer edge (CE) device. The PE device transmits the ARP request message to other locally connected CE devices and generates an IP address resolution request message that includes the IP address of a destination CE device. The IP address resolution request message is transmitted to other PE devices within the network. The PE device receives remote adjacency information associated with the destination CE device and transmits an ARP reply message to the locally connected CE device.

### TECHNICAL FIELD

The present disclosure generally relates to the field of computer networking, particularly with regard to the extension of existing routing control planes for Internet Protocol (IP) address resolution in different networking environments.

### BACKGROUND

Layer 2 (L2) ethernet networks often provide flooding (e.g., broadcasting) mechanisms to allow for Layer 3 (L3) Internet Protocol (IP) adjacency resolution, such as through the Address Resolution Protocol (ARP) for IPV4 networks or through the Neighbor Discovery Protocol (NDP) for IPv6 networks. For large network deployments, the L2 flooding domain may be emulated through an Ethernet Virtual Private Network (EVPN) overlay, a Virtual Private Local Area Network Service (VPLS) overlay, or any other services overlay. However, the emulation of L2 flooding domains can introduce scaling and performance challenges, especially in cloud computing environments where packet forwarding is provided through software implementations.

These scaling and performance challenges are also present in Internet Exchange Points (IXPs). For instance, in IXP, most of the customer edge (CE) devices are peered with provider edge (PE) devices or routers, where Broadcast, Unknown-Unicast and Multicast (BUM) network traffic is sourced by ARP/NDP resolution procedures. Another challenge in IXPs concerns the high volume of static ARP/NDP entries being programmed. For instance, the static mapping table may pose an issue as the dynamicity lost, resulting in IXP networks being more difficult to manage. This may result in CE device motion being broken.

### BRIEF DESCRIPTION OF THE FIGURES

To provide a more complete understanding of the present disclosure and features and advantages thereof, reference is made to the following description, taken in conjunction with the accompanying drawings, in which:

FIG. 1 shows an illustrative example of a flow diagram corresponding to a process for ARP resolution that extends an existing routing control plane in accordance with at least one embodiment;

FIGS. 2A-2B show an illustrative example of an environment in which a multipoint IP gateway local intra-subnet routing is performed through an interface implemented within a PE device within a network in accordance with at least one embodiment;

FIGS. 3A-3C show an illustrative example of an environment in which a multipoint IP gateway remote inter-subnet routing is performed through interfaces implemented within PE devices within a network in accordance with at least one embodiment;

FIG. 4 shows an illustrative example of an environment in which a data packet is forwarded using multipoint IP gateway remote intra-subnet routing to a CE device within a network in accordance with at least one embodiment;

FIG. 5 shows an illustrative example of a process for flooding a received ARP request message to locally connected CE devices and transmitting an IP address resolution request message corresponding to the ARP request to other remote PE devices within a network to obtain destination CE device remote adjacency information in accordance with at least one embodiment;

FIG. 6 shows an illustrative example of a process for obtaining and advertising adjacency information associated with a destination CE device in response to a received IP address resolution request message in accordance with at least one embodiment;

FIG. 7 illustrates an example network device suitable for performing switching, routing, and other networking operations in accordance with some embodiments; and

FIG. 8 illustrates a computing system architecture including various components in electrical communication with each other using a connection in accordance with some embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

Disclosed herein are systems, methods and computer-readable storage media for performing IP address resolution within a network through a control plane or network controller approach.

In an example, a computer-implemented method comprises receiving an ARP request. The ARP request indicates a destination IP address and a broadcast Media Access Control (MAC) address. Further, the ARP request is associated with a first CE device. The computer-implemented method further comprises transmitting the ARP request to a set of locally connected CE devices. The computer-implemented method further comprises generating an IP address resolution request message. When the IP address resolution request message is generated, the IP address resolution request message is transmitted to a set of remote PE devices. The computer-implemented method further comprises receiving remote adjacency information associated with a second CE device. The second CE device is connected to a remote PE device from the set of remote PE devices. The computer-implemented method further comprises transmitting an ARP reply to the first CE device. The ARP reply includes a MAC address associated with the second CE device.

In an example, the IP address resolution request message is transmitted through a border gateway protocol (BGP).

In an example, the computer-implemented method further comprises withdrawing the IP address resolution request message in response to receiving the remote adjacency information associated with the second CE device.

In an example, the ARP request and the IP address resolution request message are transmitted through a gateway interface implemented on a PE device locally connected to the first CE device.

In an example, the remote PE device automatically advertises the remote adjacency information in response to receiving another ARP reply associated with the second CE device.

In an example, the remote PE device transmits a new ARP request to the second CE device and other CE devices connected to the remote PE device in response to receiving the IP address resolution request message. Further, the new ARP request indicates the destination IP address.

In an example, the MAC address associated with the second CE device included in the ARP reply is a proxy MAC address that obfuscates an actual MAC address of the second CE device.

In an example, a system comprises one or more processors and memory storing thereon instructions that, as a result of being executed by the one or more processors, cause the system to receive an ARP request. The ARP request indicates a destination IP address and a broadcast MAC address. Further, the ARP request is associated with a first CE device. The instructions further cause the system to transmit the ARP request to a set of locally connected CE devices. The instructions further cause the system to generate an IP address resolution request message. When the IP address resolution request message is generated, the IP address resolution request message is transmitted to a set of remote PE devices. The instructions further cause the system to receive remote adjacency information associated with a second CE device. The second CE device is connected to a remote PE device from the set of remote PE devices. The instructions further cause the system to transmit an ARP reply to the first CE device. The ARP reply includes a MAC address associated with the second CE device.

In an example, a non-transitory computer-readable storage medium stores thereon executable instructions that, as a result of being executed by one or more processors of a computer system, cause the computer system to receive an ARP request. The ARP request indicates a destination IP address and a broadcast MAC address. Further, the ARP request is associated with a first CE device. The executable instructions further cause the computer system to transmit the ARP request to a set of locally connected CE devices. The executable instructions further cause the computer system to generate an IP address resolution request message. When the IP address resolution request message is generated, the IP address resolution request message is transmitted to a set of remote PE devices. The executable instructions further cause the computer system to receive remote adjacency information associated with a second CE device. The second CE device is connected to a remote PE device from the set of remote PE devices. The executable instructions further cause the computer system to transmit an ARP reply to the first CE device. The ARP reply includes a MAC address associated with the second CE device.

### DESCRIPTION OF EXAMPLE EMBODIMENTS

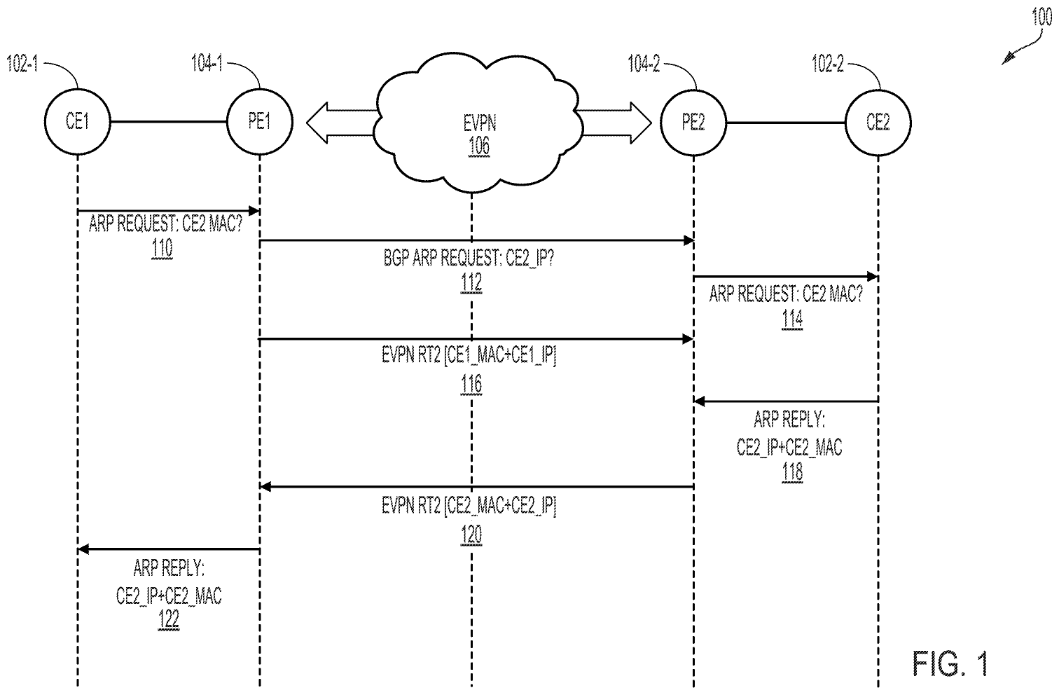

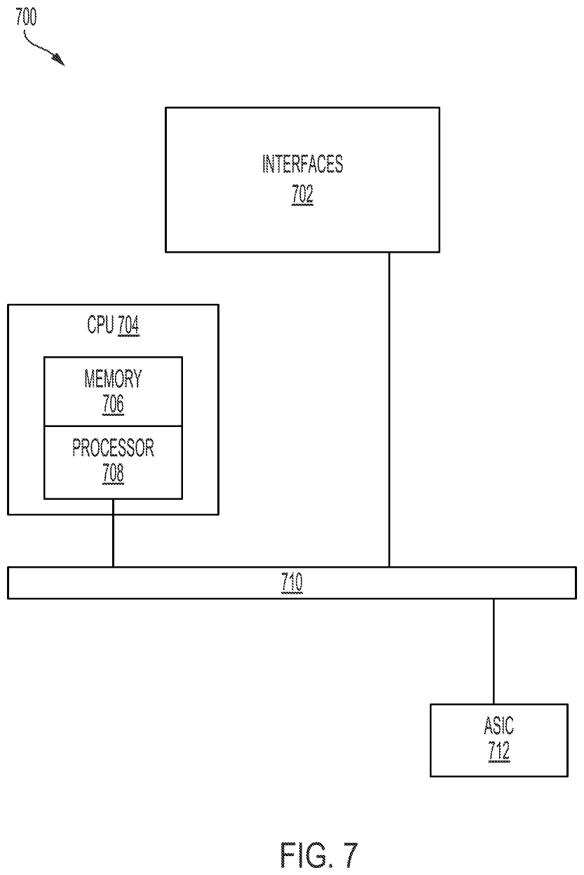

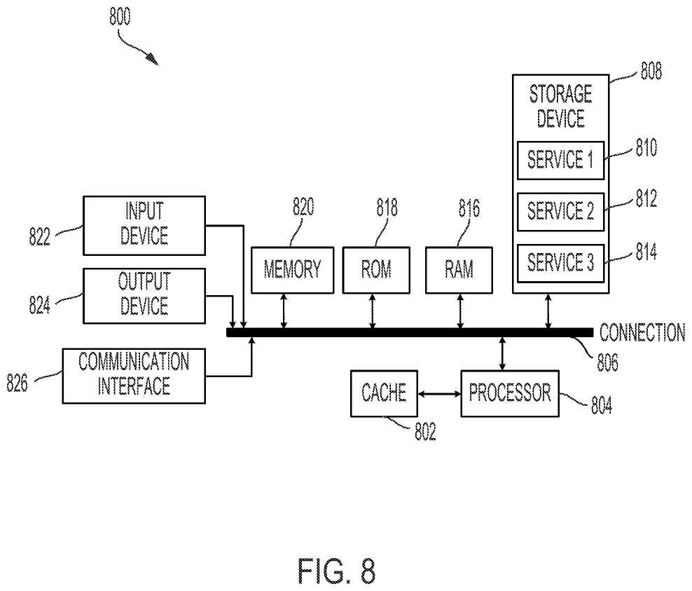

Disclosed herein are systems, methods and computer-readable storage media for performing IP address resolution within a network through a control plane or network controller approach. The present technologies will be described in more detail in the following disclosure as follows. The discussion begins with a detailed description of example systems, processes and environments for performing the aforementioned IP address resolution within a network through the control plane or network controller, as illustrated in FIGS. 1 through 6. The discussion concludes with a description of an example network and computing devices, as illustrated in FIGS. 7 and 8.

FIG. 1 shows an illustrative example of a flow diagram 100 corresponding to a process for ARP resolution that extends an existing routing control plane in accordance with at least one embodiment. As illustrated in FIG. 1, an Ethernet Virtual Private Network (EVPN) 106 is implemented. The EVPN 106 may provide Ethernet multipoint services over Multiprotocol Label Switching (MPLS) networks. In an embodiment, the EVPN 106 enables control plane-based MAC learning in the core. Further, PE devices operating within the network illustrated in FIG. 1 (e.g., PE devices 104-1 and 104-2) may learn CE device MAC routes in the control plane through use of the multiprotocol BGP (MP-BGP) protocol. It should be noted that while BGP is used throughout the present disclosure for the purpose of illustration, other control plane protocols, network controllers, or network management systems may be implemented.

At step 110, CE device 102-1 may transmit an ARP request to the PE device 104-1 within the network. The CE device 102-1 may be locally connected to the PE device 104-1 through an interface implemented on the PE device 104-1. The interface may be implemented as an application or other executable process within the PE device 104-1 through a virtual routing and forwarding (VRF) instance executed on the PE device 104-1. The connection between the CE device 102-1 and the interface implemented through the VRF instance of the PE device 104-1 may be facilitated via L3 access control (L3AC). It should be noted that while the present network illustrated in FIG. 1 includes a single local connection between a CE device 102-1 and the PE device 104-1, any number of CE devices may be locally connected to the PE device 104-1. It should be noted that while an interface is described extensively throughout the present disclosure as providing connectivity between CE devices and PE devices, other connectivity methods may be implemented. For instance, such connectivity may be performed using standard L3 interfaces/sub-interfaces where host routing is enabled.

In an embodiment, the ARP request from the CE device 102-1 include the IP address of the destination CE device to which the CE device 102-1 would like to transmit a data packet, in this case CE device 102-2. Additionally, the ARP request from the CE device 102-1 may indicate a broadcast MAC address (e.g., “ff: ff: ff: ff: ff: ff”). The broadcast MAC address included in the ARP request may serve as an indication that data is to be transmitted to all of the hosts in the local subnet.

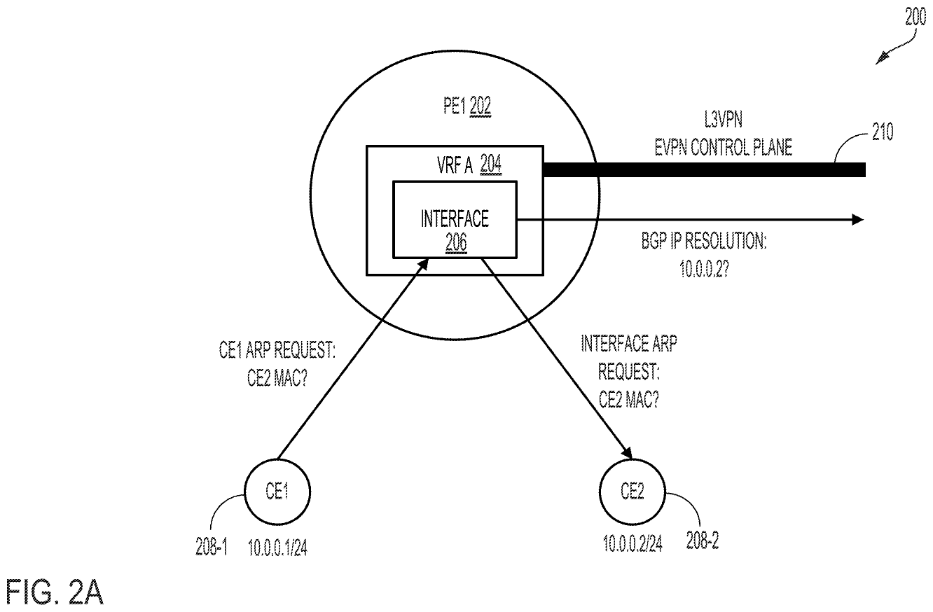

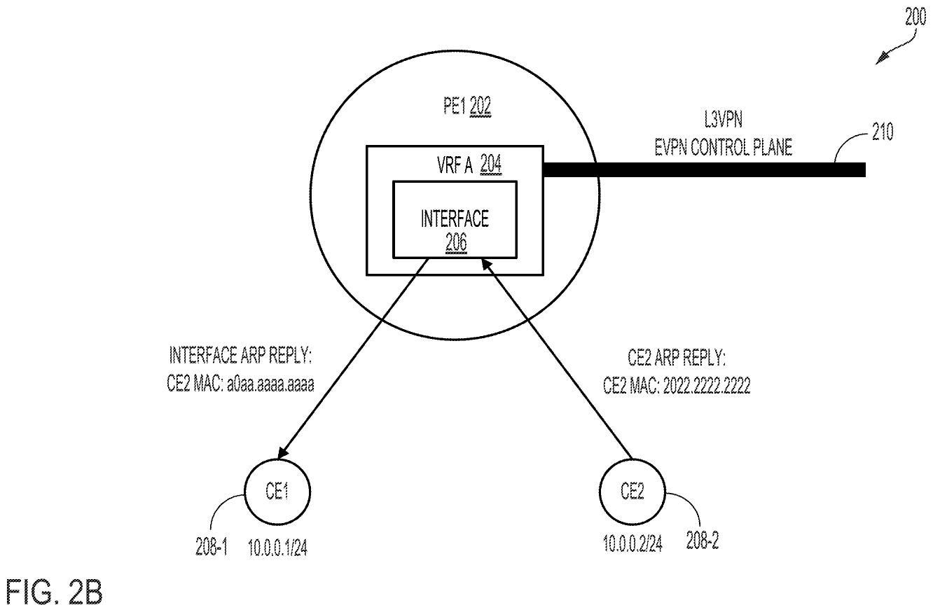

In response to the ARP request from the CE device 102-1, the PE device 104-1 may transmit the ARP request to any other locally connected CE devices within the subnet. For example, if the PE device 104-1 is locally connected via L3AC to multiple CE devices, the PE device 104-1 may locally broadcast the ARP request to each of these CE devices to solicit a reply to the ARP request. This process is described and illustrated in greater detail in connection with FIGS. 2A-2B. However, as illustrated in FIG. 1, the PE device 104-1 may be locally connected to a single CE device 102-1. Thus, in this particular example, the PE device 104-1 may not be required to transmit the ARP request to other CE devices within the network.

At step 112, PE device 104-1, through the interface, may generate an IP address resolution request message. The IP address resolution request message may indicate the IP address of the destination CE device (e.g., CE device 102-2). The IP address resolution request message may be transmitted, through the EVPN core 106 to all other remote PE devices within the network (e.g., PE device 104-2, as illustrated in FIG. 1). The IP address resolution request message may be transmitted to the other remote PE devices within the network through BGP, one or more network controllers, a network management system, and the like. For instance, as illustrated in FIG. 1 and as part of step 112, this IP address resolution request message may be transmitted to PE device 104-2 through a BGP ARP request generated by the interface associated with the PE device 104-1.

At step 114, the PE device 104-2, in response to receiving the IP address resolution request message from PE device 104-1 over the EVPN core 106, may transmit an ARP request message to all locally connected CE devices (e.g., CE device 102-2) sharing a common subnet/local area network (LAN). Similar to PE device 104-1, PE device 104-2 may execute an interface implemented as an application or other executable process within the PE device 104-2 through a VRF instance executed on the PE device 104-2. Further, the PE device 104-2 may be locally connected to CE device 102-2 via L3AC. The ARP request message generated by the interface implemented on the PE device 104-2 may include the IP address of the destination CE device (e.g., CE device 102-2) as originally indicated by CE device 102-1 in its ARP request to PE device 104-1.

In addition to transmitting this IP address resolution request message, the PE device 104-1, at step 116 and through the interface, may advertise the MAC address and IP address of the CE device that originally submitted the ARP request (e.g., CE device 102-1). The MAC address and IP address of this CE device 102-1 may be advertised through a MAC/IP advertisement route (otherwise referred to as an EVPN Type 2 route). The PE device 104-1 may learn the MAC and IP addresses of the CE device 102-1 directly connected to the PE device 104-1 through standard data plane learning mechanisms. In some instances, the PE device 104-1 may learn the MAC and IP addresses of the CE device 102-1 through control plane interaction between the PE device 104-1 and the CE device 102-1, as described in the Internet Engineering Task Force (IETF) Request for Comments (RFC) 7432, which is incorporated in its entirety into the present disclosure by reference.

In an embodiment, a new EVPN route type may be defined that allows for prioritization of route exchanges and backward interoperability with existing device types. For instance, a new EVPN route type for IP address resolution may include an Ethernet Segment Identifier (ESI) that may enable avoidance of probing over the originated access segment where the request was originated. Further, the new EVPN route type may include an ethernet tag identifier to support VLAN-aware bundle mode as with other routes. The new EVPN route type may further include the source and destination MAC addresses, as well as a source prefix address that indicates the IP address of the CE device or other host initiating the request. The new EVPN route type may also include a destination IP address that is to be used for probing. The destination IP address may be defined through either IPv4 or IPv6. It should be noted that the new EVPN route type may include additional fields. For instance, one or more BGP extended community attributes may be used to carry a set of flags, such as those defined in IETF RFC 9047, which is incorporated in its entirety into the present disclosure by reference. In some instances, a new BGP address family may be enabled, which may eliminate the need for packet flooding where different route types may solve different protocols.

At step 118, the CE device 102-2, which may correspond to the IP address indicated in the original ARP request submitted by the CE device 102-1 to the PE device 104-1, may respond to the ARP request from the PE device 104-2 with an ARP reply message. The ARP reply message may indicate the MAC and IP addresses of the CE device 102-2, thereby indicating that the CE device 102-2 is the intended destination corresponding to the request submitted by CE device 102-1. The CE device 102-2 may transmit the ARP reply message to PE device 104-2 to indicate its association with the IP address indicated in the ARP request transmitted by the PE device 104-2.

At step 120, the PE device 104-2 may advertise the remote adjacency information associated with CE device 102-2 to all remote PE devices within the network, including PE device 104-1. The PE device 104-2 may advertise this remote adjacency information through the interface implemented on the PE device 104-2. The remote adjacency information transmitted by the PE device 104-2 may include the MAC and IP addresses of the CE device 102-2 as provided by the CE device 102-2 through the ARP reply message described above. Further, the remote adjacency information may be advertised to the other PE devices (including PE device 104-1) in the network through the EVPN core 106 via an EVPN Type 2 route.

In response to receiving the remote adjacency information corresponding to CE device 102-2 through the EVPN Type 2 route message, the PE device 104-1, at step 122, may transmit an ARP reply message to CE device 102-1. The ARP reply message from the PE device 104-1 may indicate the IP address of the CE device 102-2, as well as a MAC address associated with the CE device 102-2. In an embodiment, the MAC address associated with the CE device 102-2 may be obfuscated through indication of a proxy MAC address. The proxy MAC address may be different from the actual MAC address provided by the CE device 102-2 in its ARP reply message to PE device 104-2. The association between the actual MAC address of the CE device 102-2 and the proxy MAC address may be generated by the interface of the PE device 104-1. Further, the proxy MAC address may be further generated by the interface of the PE device 104-1. This may prevent exposure of the actual MAC address of the CE device 102-2 to the requesting CE device (e.g., CE device 102-1). The PE device 104-1 may only transmit an ARP reply message to the CE device 102-1 when the host route for the IP address being requested (e.g., the IP address corresponding to CE device 102-2) is installed in the forwarding information base (FIB). This may prevent the PE device 104-1 from automatically responding to the CE device 102-1 immediately upon receiving the ARP request message described above.

In an embodiment, once the PE device 104-1 has provided an ARP reply message to the CE device 102-1 indicating the IP address and proxy MAC address associated with CE device 102-2, the PE device 104-1 may withdraw the initial IP address resolution request message submitted through the EVPN core 106. The initial IP address resolution request message may be withdrawn as a result of the underlying request having been resolved by the PE device 104-2 and the corresponding CE device 102-2.

It should be noted that while EVPN is used extensively throughout the present disclosure for the purpose of illustration, other network control planes may be used for address resolution. For instance, rather than transmitting an EVPN Type 2 route message through the EVPN core 106 to the PE device 104-1, the PE device 104-2 may transmit an ARP reply message that encodes the MAC and IP addresses of the CE device 102-2 via the L2 data plane directly to PE device 104-1. As the ARP reply message from PE device 104-2 to PE device 104-1 is a unicast data packet, flooding is avoided.

FIGS. 2A-2B show an illustrative example of an environment 200 in which a local intra-subnet routing is performed through an interface 206 implemented within a PE device 202 within a network in accordance with at least one embodiment. In the environment 200, and as illustrated in FIG. 2A, the PE device 202 may be locally connected (such as through a subnet) to a set of CE devices (e.g., CE device 208-1 and CE device 208-2). These local connections may be facilitated through the interface 206 implemented on the PE device 202. In an embodiment, the interface 206 is implemented through a VRF instance 204 (e.g., VRF A) executed on the PE device 202. Additionally, the local connections between the PE device 202 (through the interface 206) and the CE devices 208-1, 208-2 may be facilitated via L3AC, as described above.

In the environment 200, CE device 208-1 transmits an ARP request message to the interface 206 of the PE device 202 to identify the MAC address corresponding to a destination CE device (e.g., CE device 208-2). The ARP request message from CE device 208-1 may indicate the IP address of the destination CE device (e.g., CE device 208-2) to which the CE device 208-1 would like to transmit a data packet. Further, as noted above, the initial ARP request message from the CE device 208-1 may include a broadcast MAC address, which may serve as an indication that data is to be transmitted to all of the hosts within the local subnet.

As illustrated in FIG. 2A, the interface 206 of the PE device 202 may process the ARP request message from the CE device 208-1 and transmit the received ARP request message to all other locally connected CE devices within the subnet (e.g., CE device 208-2). Additionally, the interface 206 may generate an IP address resolution request message that may be transmitted, through the EVPN control plane 210 to all other remote PE devices within the L3 virtual private network (L3VPN). This IP address resolution message may be transmitted to the other remote PE devices within the L3VPN through BGP, one or more network controllers, a network management system, or other available method. However, as illustrated in FIGS. 2A-2B, the CE device corresponding to the IP address indicated in the original ARP request message transmitted by CE device 208-1 is located within the local subnet of PE device 202. Thus, the PE device 202 may not receive an ARP reply message from any other PE devices within the L3VPN.

As illustrated in FIG. 2B, CE device 208-2, in response to receiving the ARP request message from the interface 206 of the PE device 202, may transmit an ARP reply message indicating that CE device 208-2 corresponds to the IP address indicated in the ARP request message. The ARP reply message from the CE device 208-2 may indicate the MAC and IP addresses of the CE device 208-2, thereby indicating that the CE device 208-2 is the intended destination corresponding to the ARP request submitted by the CE device 208-1 within the subnet.

In response to receiving the ARP reply message from the CE device 208-2, the interface 206 may generate a proxy MAC address that is associated with the CE device 208-2 but that otherwise obfuscates the actual MAC address of the CE device 208-2. For example, as illustrated in FIG. 2B, the interface 206 may generate the proxy MAC address “a0aa.aaaa aaaa” for the CE device 208-2 and associate this proxy MAC address with the actual MAC address of CE device 208-2 (e.g., “2022.2222.2222”). The interface 206 may maintain a lookup table or other data structure through which actual MAC addresses may be associated with newly generated proxy MAC addresses. This may allow the interface 206, in response to receiving a data packet having an ethernet header that indicates a proxy MAC address as the destination MAC address for the data packet, to query the lookup table or other data structure using the indicated proxy MAC address to obtain the actual MAC address of the destination CE device.

The interface 206 of the PE device 202 may transmit an ARP reply message to the CE device 208-1 that includes the proxy MAC address generated by the interface 206. Accordingly, when the CE device 208-1 transmits or forwards a data packet that is destined for CE device 208-2, the CE device 208-1 may include the proxy MAC address associated with the CE device 208-2 as the destination MAC address in the ethernet header. In response to receiving this data packet, the PE device 202, through the interface 206, may parse the ethernet header to obtain the destination MAC address which, in this case, may be the proxy MAC address for CE device 208-2 previously generated by the interface 206. Accordingly, the interface 206 may query its MAC address lookup table or other data structure to determine whether the MAC address provided in the ethernet header corresponds to an actual MAC address of a CE device locally connected to the PE device 202 within the subnet. If so, the interface 206 may identify the actual MAC address of the CE device 208-2 and use this actual MAC address to transmit the data packet to the CE device 208-2.

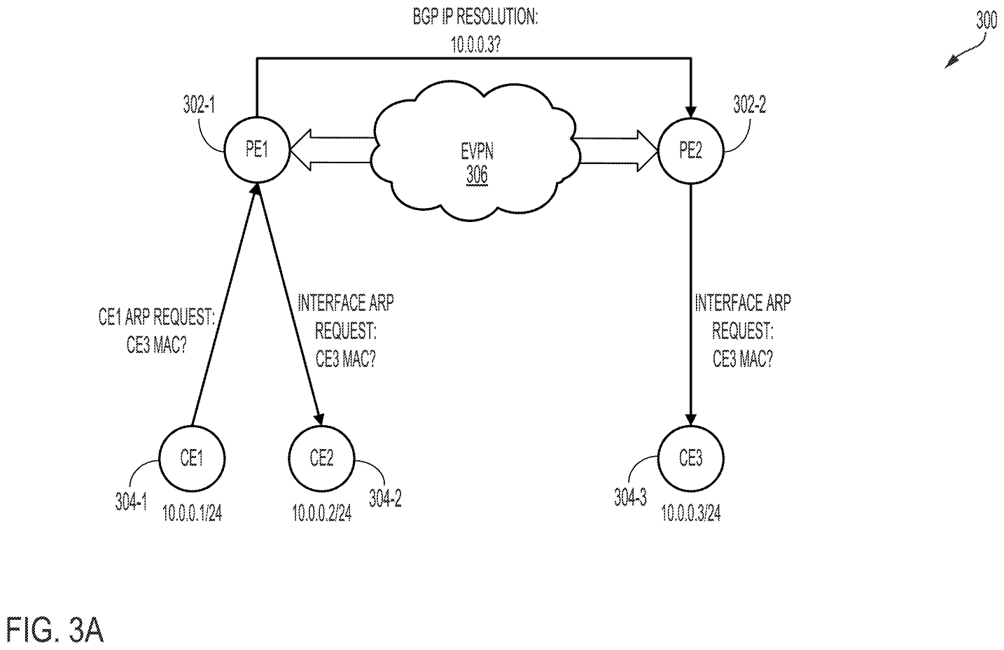

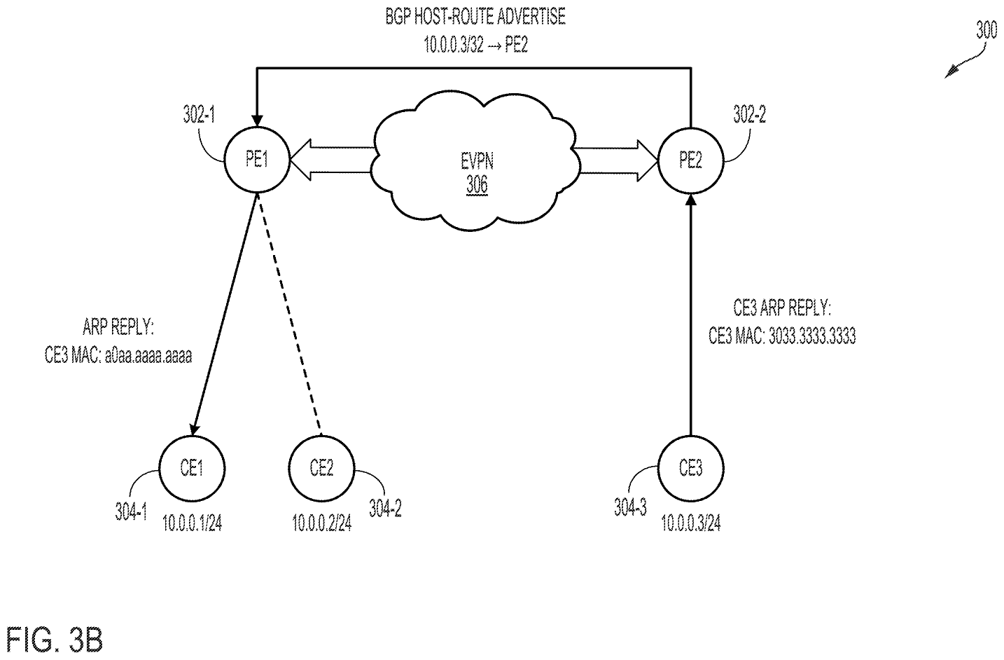

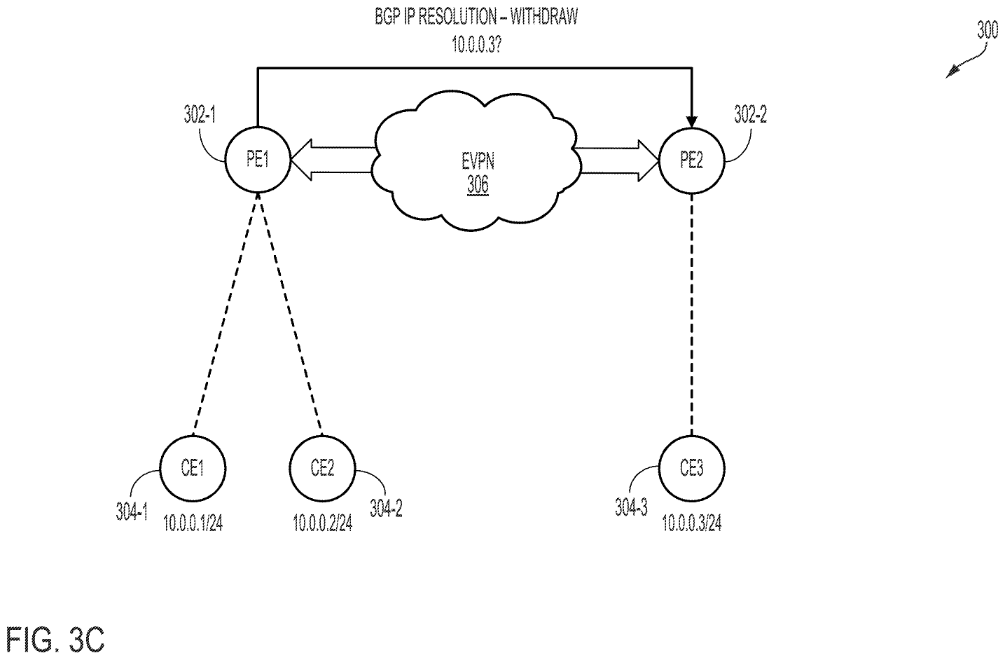

FIGS. 3A-3C show an illustrative example of an environment 300 in which a remote inter-subnet routing is performed through interfaces implemented within PE devices 302-1, 302-2 within a network in accordance with at least one embodiment. In the environment 300, and as illustrated in FIG. 3A, a CE device 304-1 locally connected to PE device 302-1 within a subnet may transmit an ARP request message to the interface of the PE device 302-1. Similar to the PE device 202 described above in connection with FIGS. 2A-2B, the PE device 302-1 may be locally connected (such as through a subnet) to a set of CE devices (e.g., CE device 304-1 and CE device 304-2). These local connections may be facilitated through an interface implemented on the PE device 302-1. The interface is implemented through a VRF instance executed on the PE device 302-1 and the local connections between the PE device 302-1 (and the CE devices 304-1, 304-2 may be facilitated via L3AC through the interface of the PE device 302-1.

As illustrated in FIG. 3A, the CE device 304-1 may transmit an ARP request message that includes the IP address of a destination CE device (e.g., CE device 304-3) that may not be part of the local subnet associated with PE device 302-1. Similar to the ARP request messages described above from originating CE devices, the ARP request message from the CE device 304-1 may further include a broadcast MAC address, which may serve as an indication that data is to be transmitted to all hosts (e.g., other CE devices) within the local subnet.

In response to the ARP request message from the CE device 304-1, the PE device 302-1 may transmit the ARP request to the other CE devices locally connected to the interface of the PE device 302-1 within the local subnet. For instance, as illustrated in FIG. 3A, the PE device 302-1 may flood the ARP request from CE device 304-1 to CE device 304-2 within the subnet and that is locally connected to PE device 302-1. The ARP request message from the PE device 302-1 may be generated by the interface implemented by the PE device 302-1 within a VRF instance. The ARP request message from the PE device 302-1 may include the IP address of the destination CE device (e.g., CE device 304-3 in this illustrative example). Accordingly, CE device 304-2 may not return an ARP reply message as it does not correspond to the IP address indicated in the ARP request message.

In addition to transmitting an ARP request message to the other CE devices locally connected to the PE device 302-1 in the subnet, the PE device 302-1, through the interface, may generate an IP address resolution request message that indicates the IP address of the destination CE device (e.g., CE device 304-3). The IP address resolution request message generated by the interface of the PE device 302-1 may be transmitted through the EVPN core 306 to all other PE devices within the L3VPN, including PE device 302-2 using BGP, one or more network controllers, a network management system, or other available method associated with the L3VPN. As illustrated in FIG. 3A, the PE device 302-1, through its interface, may transmit a BGP ARP request message that includes the IP address of the destination CE device (e.g., CE device 304-3) as indicated by the CE device 304-1 in its original ARP request message to the PE device 302-1.

The interface of PE device 302-1 may further advertise the MAC address and IP address of CE device 304-1, which transmitted the original ARP request message to the PE device 302-1. The MAC address and IP address of this CE device 304-1 may be advertised through a an EVPN Type 2 route. As noted above, the PE device 302-1 may learn the MAC and IP addresses of the CE device 304-1 directly connected to the PE device 302-1 through standard data plane learning mechanisms. In some instances, the PE device 302-1 may learn the MAC and IP addresses of the CE device 304-1 through control plane interaction between the PE device 302-1 and the CE device 304-1, as described above.

In response to receiving the BGP ARP request message from the PE device 302-1 through the EVPN core 306, PE device 302-2 may generate an ARP request message that may be transmitted to all locally connected CE devices within its subnet (e.g., CE device 304-3). Similar to PE device 302-1 described above, the PE device 302-2 may implement a VRF instance through which the PE device 302-2 may execute an interface. CE device 304-3 may be locally connected to this interface through L3AC. The ARP request message generated by the interface in response to the BGP ARP request message from the PE device 302-1 may include the IP address of the intended destination CE device (e.g., CE device 304-3) as originally indicated by CE device 304-1 in its original ARP request message transmitted to the PE device 302-1, as described above.

As illustrated in FIG. 3B, CE device 304-3, which may correspond to the IP address indicated in the ARP request message from the PE device 302-2, may generate an ARP reply message that includes the MAC address of CE device 304-3 (e.g., “3033.3333.3333”) and the IP address of the CE device 304-3. The ARP reply message, as described above, may serve as an indication that CE device 304-3 is the intended destination referred to by CE device 304-1 in its original ARP request message to its locally connected PE device 302-1. The CE device 304-3 may transmit this ARP reply message to PE device 302-2 in response to the ARP request message transmitted by through the interface of PE device 302-2.

In response to the ARP reply message from CE device 304-3, the PE device 302-2 may advertise the remote adjacency information associated with CE device 304-3 (as provided in the ARP reply message) to all remote PE devices within the L3VPN (e.g., PE device 302-1, as illustrated in FIG. 3B). The PE device 302-2 may advertise this remote adjacency information through the interface implemented on the PE device 302-2. The remote adjacency information transmitted by the PE device 302-2 may include the MAC and IP addresses of the CE device 304-3 as indicated in the ARP reply message transmitted by CE device 304-3. Further, the remote adjacency information may be advertised to the PE device 302-1 in the L3VPN through the EVPN core 106 via an EVPN Type 2 route.

The PE device 302-1, in response to receiving the remote adjacency information from the PE device 302-2 through the EVPN core 306, may transmit an ARP reply message to the CE device 304-1 that originally submitted the ARP request message indicating the intended destination IP address. The ARP reply message from the PE device 302-1 may indicate the IP address and a MAC address associated with the CE device 304-3. In an embodiment, the MAC address associated with the CE device 304-3 is obfuscated through indication of a proxy MAC address that corresponds to the actual MAC address of the CE device 304-3. For instance, the proxy MAC address may be different from the actual MAC address provided by the CE device 304-3 in its ARP reply message to PE device 302-2. The association between the actual MAC address of the CE device 304-3 and the proxy MAC address may be recorded by the interface of the PE device 302-1. Additionally, upon receiving the remote adjacency information corresponding to the CE device 304-3, the interface of PE device 302-1 may generate the proxy MAC address. As noted above, the generation and transmission of a proxy MAC address instead of the actual MAC address of the CE device 304-3 may prevent exposure of the actual MAC address to the requesting CE device (e.g., CE device 304-1).

As illustrated in FIG. 3C, once the PE device 302-1, through its interface, has transmitted an ARP reply message to CE device 304-1 indicating a proxy MAC address for the destination IP address corresponding to CE device 304-3, the PE device 302-1 may withdraw the initial IP address resolution request message submitted through the EVPN core 306. The initial IP address resolution request message may be withdrawn as a result of the underlying request having been resolved by the PE device 302-2 and the corresponding CE device 304-3 that submitted the appropriate ARP reply message in response to the original ARP request message from CE device 304-1.

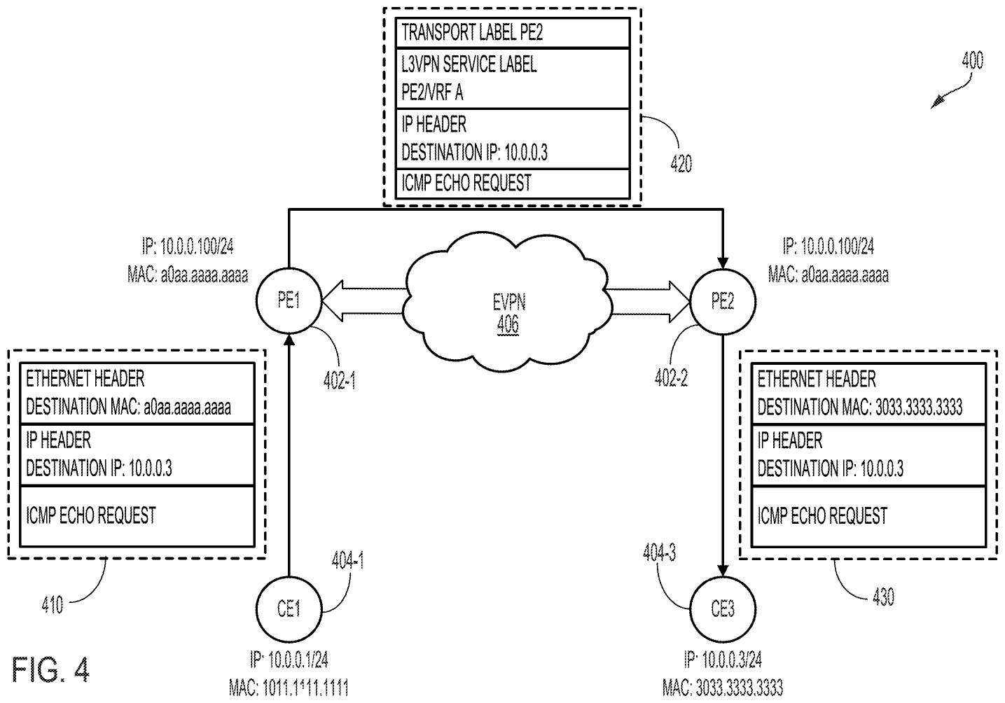

FIG. 4 shows an illustrative example of an environment 400 in which a data packet 410 is forwarded using remote inter-subnet routing to a CE device 404-3 within a network in accordance with at least one embodiment. In the environment 400, a CE device 404-1 within a first subnet may forward a data packet 410 that is destined for a CE device 404-3 within a second subnet of a L3VPN to a PE device 402-1 within the first subnet. The CE device 404-1 may be locally connected to the PE device 402-1 through an interface implemented by the PE device 402-1. This local connection may be facilitated through L3AC, as noted above.

In the environment 400, the CE device 404-1 may indicate, in the data packet 410, the destination IP address corresponding to the CE device 404-3 through an IP header. Further, through an ethernet header of the data packet 410, the CE device 404-1 may indicate the destination MAC address associated with the CE device 404-3. As noted above, in response to an ARP request message requesting a MAC address associated with the CE device 404-3, the PE device 402-1, through its interface, may provide a proxy MAC address that may correspond to the actual MAC address of the CE device 404-3 (as determined according to the process described above in connection with FIGS. 3A-3C, etc.). Accordingly, when the CE device 404-1 forwards a data packet 410 destined for CE device 404-3, the CE device 404-1 may indicate, through the ethernet header, the proxy MAC address associated with the CE device 404-3 and previously provided by the PE device 402-1.

In response to receiving the data packet 410 from CE device 404-1, the PE device 402-1, through its interface, may attach a transport label and a L3VPN service label to the data packet 410 (resulting in data packet 420) to allow for transmission of the data packet 420 to PE device 402-2 through the EVPN core 406. As illustrated in FIG. 4, through the transport and L3VPN labels, the PE device 402-1 may indicate that the PE device 402-2 is the intended destination of the data packet 420 for further routing of the data packet 420 to the intended destination (e.g., CE device 404-3). In addition to these labels, the data packet 420 may indicate the IP address of the intended destination of the data packet 420, as originally indicated by CE device 404-1. The data packet 420 may be transmitted to the PE device 402-2 via the EVPN core 406 through Multiprotocol Label Switching (MPLS), which may route network traffic (such as data packet 420) using the shortest path based on the labels contained therein. As noted above, the data packet 420 may include a transport label and a L3VPN service label through which the PE device 402-1 may indicate that the PE device 402-2 is the next destination for the data packet 420.

The PE device 402-2, in response to receiving the data packet 420 from the PE device 402-1 through the EVPN core 406, may identify the actual MAC address of the CE device 404-3 that is indicated as being the destination for the data packet 420. According to the process described above in connection with FIGS. 3A-3B, in response to an ARP reply message from the CE device 404-3 resulting from an initial ARP request message from CE device 404-1 to determine the MAC address of CE device 404-3, the PE device 402-2 may generate a proxy MAC address corresponding to the actual MAC address of the CE device 404-3. Accordingly, when the PE device 402-2 receives the data packet 420 indicating the proxy MAC address originally specified by the CE device 404-1 in the original data packet 410, the PE device 402-2 may query its MAC address lookup table or other data structure to determine whether the MAC address provided in the data packet 420 corresponds to an actual MAC address of a CE device locally connected to the PE device 402-2 within the subnet.

As illustrated in FIG. 4, the proxy MAC address corresponding to the CE device 404-3, “a0aa.aaaa aaaa,” may be associated with the actual MAC address of the CE device 404-3, “3033.3333.3333.” In an embodiment, PE device 402-2, upon identifying the actual MAC address corresponding to the proxy MAC address specified in data packet 420, the PE device 402-2 may generate a data packet 430 that indicates, for the ethernet header, a destination MAC address corresponding to the actual MAC address of CE device 404-3. The data packet 430 may include the original IP header previously incorporated into the original data packet 410 transmitted by CE device 404-1, whereby the IP header of data packet 430 may indicate the IP address of CE device 404-3. Once the PE device 402-2 has generated data packet 430, the PE device 402-2 may forward the data packet 430 to CE device 404-3.

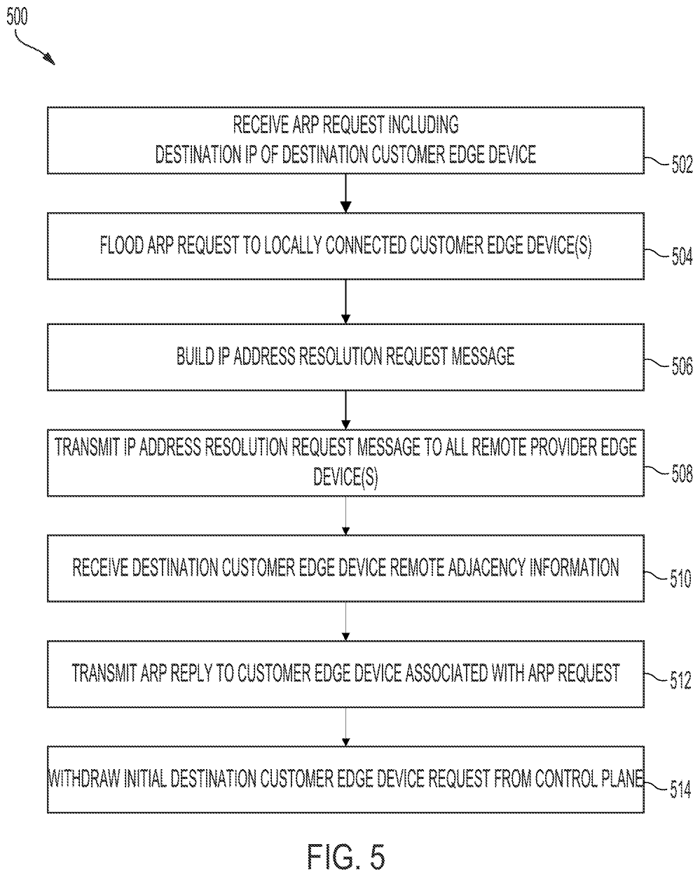

FIG. 5 shows an illustrative example of a process 500 for flooding a received ARP request message to locally connected CE devices and transmitting an IP address resolution request message corresponding to the ARP request to other remote PE devices within a network to obtain destination CE device remote adjacency information in accordance with at least one embodiment. The process 500 may be performed by a PE device receiving an ARP request message from a locally connected CE device to determine the MAC address of a destination CE device within a L3VPN. As noted above, the PE device may implement, within a VRF instance, an interface that may facilitate the operations described herein. Further, CE devices within the same subnet of the PE device may be locally connected to the PE device through the interface via L3AC.

At step 502, the interface of the PE device may receive an ARP request message from a CE device locally connected to the interface through L3AC. The ARP request message may include a destination IP address corresponding to a particular CE device within the L3VPN. This particular CE device may be another CE device that is locally connected to the interface of the PE device through L3VPN such that the particular CE device may be within the same subnet as the CE device that generated the ARP request message. Alternatively, the particular CE device may be connected to another PE device within the L3VPN. The ARP request message may further indicate a broadcast MAC address, which may serve as an indication that data is to be transmitted to all of the hosts in the local subnet.

At step 504, the PE device may flood the ARP request message to all other locally connected CE devices within the subnet. For instance, if the PE device is locally connected via L3AC to multiple CE devices in the subnet, the PE device may locally broadcast the ARP request message from the originating CE device to the other locally connected CE devices to solicit a reply to the ARP request message.

In addition to transmitting the ARP request message to all other CE devices locally connected to the interface of the PE device, the interface of the PE device, at step 506, may build an IP address resolution request message. The IP address resolution request message may indicate the IP address of the destination CE device or host, as specified by the originating CE device. At step 508, the interface of the PE device may transmit the IP address resolution request message through the EVPN core of the L3VPN to all other PE devices within the network. This IP address resolution message may be transmitted by the interface of the PE device through the EVPN core using BGP, one or more network controllers, a network management system, or other available method associated with the L3VPN. The IP address resolution request message, in some instances, is a BGP ARP request message that includes the IP address of the destination CE device or host as indicated by the originating CE device in its original ARP request message to the PE device.

At step 510, the PE device may receive remote adjacency information corresponding to the destination CE device or host originally indicated in the ARP request message transmitted by the originating CE device. As noted above, a PE device receiving the IP address resolution request message may transmit an ARP request message to all locally connected CE devices sharing a common subnet/LAN. If any of the locally connected CE devices correspond to the IP address indicated in the ARP request message, the locally connected CE device corresponding to this IP address may transmit an ARP reply message that includes the MAC address of the CE device. In response to the ARP reply message from the destination CE device or host, the PE device locally connected to this destination CE device or host may advertise the remote adjacency information associated with the destination CE device or host to the other PE devices within the L3VPN, including the PE device executing the process 500.

In an embodiment, the PE device receiving the ARP reply message from the destination CE device or host generates a proxy MAC address that may obfuscate the actual MAC address of the destination CE device or host but may otherwise be associated with the destination CE device or host. The proxy MAC address may be different from the actual MAC address provided by the destination CE device or host in its ARP reply message to PE device that the destination CE device or host is connected to. The association between the actual MAC address of the destination CE device or host and the proxy MAC address may be generated by the interface of the PE device locally connected to this destination CE device or host. The association between the actual MAC address of the destination CE device or host and the proxy MAC address may be stored within a lookup table or other data structure maintained by the PE device locally connected to this destination CE device or host.

In response to receiving the remote adjacency information corresponding to the destination CE device or host, the PE device, at step 512, may transmit an ARP reply message to the originating CE device that generated the original ARP request message. The ARP reply message may include the IP address and proxy MAC address associated with the destination CE device or host. Additionally, at step 514, the PE device may withdraw its initial IP address resolution message from the L3VPN control plane. The initial IP address resolution request message may be withdrawn as a result of the underlying request having been resolved by the PE device locally connected to the destination CE device or host through transmission of the remote adjacency information corresponding to the destination CE device or host.

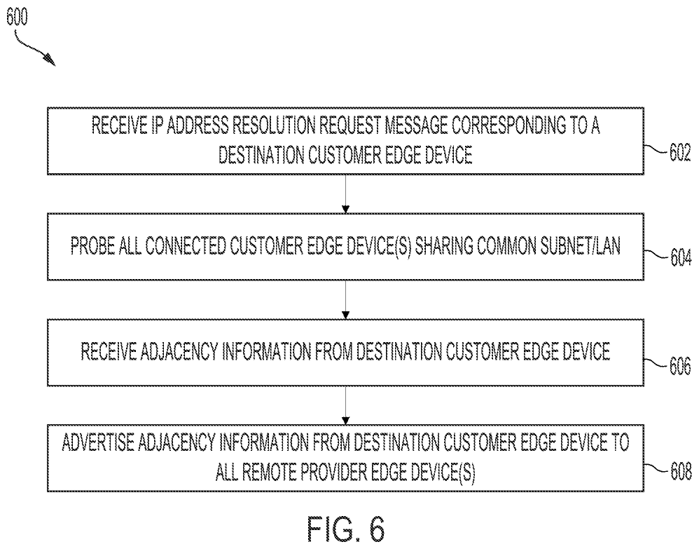

FIG. 6 shows an illustrative example of a process 600 for obtaining and advertising adjacency information associated with a destination CE device in response to a received IP address resolution request message in accordance with at least one embodiment. The process 600 may be performed by a PE device locally connected to a destination CE device or host for which a MAC address is being requested by another CE device or host within a L3VPN.

At step 602, the PE device, through its interface, may receive an IP address resolution request message corresponding to a destination CE device or host. As noted above, a PE device receiving an ARP request message from a locally connected CE device or host may generate an IP address resolution request message that indicates the IP address of the destination CE device or host. This IP address resolution message may be transmitted to the PE device executing the process 600 and to any other PE devices within the L3VPN through the EVPN core. This IP address resolution request message may be transmitted through BGP, one or more network controllers, a network management system, or any other available method associated with the network. The IP address resolution request message, as described above, may be transmitted through a BGP ARP request message generated by the PE device associated with the originating CE device or host.

At step 604, the PE device may probe all connected CE devices and hosts sharing a common subnet/LAN with the PE device. For instance, in an embodiment, the PE device generates, in response to the IP resolution request message, an ARP request message that includes the IP address of the destination CE device or host as originally indicated by the originating CE device. The PE device may transmit this ARP request message to all locally connected CE devices and hosts sharing a common subnet/LAN with the PE device.

At step 606, the PE device may receive remote adjacency information from the destination CE device or host corresponding to the IP address specified in the ARP request message transmitted by the PE device. The remote adjacency information associated with the destination CE device or host may be received via an ARP reply message. The ARP reply message may include the MAC address associated with the destination CE device or host, as well as the IP address corresponding to the destination CE device or host. In an embodiment, in response to receiving this remote adjacency information from the destination CE device or host, the PE device may define a proxy MAC address that may be associated with the destination CE device or host. This proxy MAC address may obfuscate the actual MAC address of the destination CE device or host such that the actual MAC address is not exposed to any other devices or hosts within the L3VPN. The PE device may associate the proxy MAC address to the actual MAC address through a lookup table or other data structure maintained by the PE device.

At step 608, the PE device may advertise the remote adjacency information from the destination CE device or host to all other PE devices within the L3VPN through the EVPN core. The advertised remote adjacency information may include, in lieu of the actual MAC address associated with the destination CE device or host, the proxy MAC address generated by the PE device. The remote adjacency information may be advertised by the PE device through the EVPN core via an EVPN Type 2 route or other route type. This remote adjacency information may be utilized by the PE device associated with the originating CE device that submitted the request to determine the MAC address of the destination CE device or host to generate an ARP reply message that includes the proxy MAC address associated with the destination CE device or host, as described above.

FIG. 7 illustrates an example network device 700 suitable for performing switching, routing, and other networking operations in accordance with some implementations. Network device 700 includes a CPU 704, interfaces 702, and a connection 710 (e.g., a Peripheral Component Interconnect (PCI) bus). When acting under the control of appropriate software or firmware, the CPU 704 is responsible for executing packet management, error detection, and/or routing functions. The CPU 704 can accomplish these functions under the control of software including an operating system and any appropriate applications software. The CPU 704 may include one or more processors 708, such as a processor from the Intel® X98 family of microprocessors. In some cases, the processor 708 can be specially designed hardware for controlling the operations of network device 700. In some cases, a memory 706 (e.g., non-volatile RAM, ROM, etc.) also forms part of the CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, Digital Subscriber Line (DSL) interfaces, token ring interfaces, and the like. In addition, various very high-speed interfaces may be provided such as fast token ring interfaces, wireless interfaces, Ethernet interfaces, Gigabit Ethernet interfaces, Asynchronous Transfer Mode (ATM) interfaces, High-Speed Serial Interface (HSSI) interfaces, Packet Over SONET/SDH (POS) interfaces, Fiber Distributed Data Interface (FDDI) interfaces, WiFi interfaces, 3G/4G/5G cellular interfaces, Controller Area Network (CAN) bus, Long Range (LoRa), and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 704 to efficiently perform routing computations, network diagnostics, security functions, etc.

Although the system shown in FIG. 7 is one specific network device of the present technologies, it is by no means the only network device architecture on which the present technologies can be implemented. For example, an architecture having a single processor that handles communications as well as routing computations, etc., is often used. Further, other types of interfaces and media could also be used with the network device 700.

Regardless of the network device's configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 706 could also hold various software containers and virtualized execution environments and data.

The network device 700 can also include an application-specific integrated circuit (ASIC) 712, which can be configured to perform routing and/or switching operations. The ASIC 712 can communicate with other components in the network device 700 via the connection 710, to exchange data and signals and coordinate various types of operations by the network device 700, such as routing, switching, and/or data storage operations, for example.

FIG. 8 illustrates a computing system architecture 800 including various components in electrical communication with each other using a connection 806, such as a bus, in accordance with some implementations. Example system architecture 800 includes a processing unit (CPU or processor) 804 and a system connection 806 that couples various system components including the system memory 820, such as ROM 818 and RAM 816, to the processor 804. The system architecture 800 can include a cache 802 of high-speed memory connected directly with, in close proximity to, or integrated as part of the processor 804. The system architecture 800 can copy data from the memory 820 and/or the storage device 808 to the cache 802 for quick access by the processor 804. In this way, the cache can provide a performance boost that avoids processor 804 delays while waiting for data. These and other modules can control or be configured to control the processor 804 to perform various actions.

Other system memory 820 may be available for use as well. The memory 820 can include multiple different types of memory with different performance characteristics. The processor 804 can include any general purpose processor and a hardware or software service, such as service 1 810, service 2 812, and service 3 814 stored in storage device 808, configured to control the processor 804 as well as a special-purpose processor where software instructions are incorporated into the actual processor design. The processor 804 may be a completely self-contained computing system, containing multiple cores or processors, a bus, memory controller, cache, etc. A multi-core processor may be symmetric or asymmetric.

To enable user interaction with the computing system architecture 800, an input device 822 can represent any number of input mechanisms, such as a microphone for speech, a touch-sensitive screen for gesture or graphical input, keyboard, mouse, motion input, speech and so forth. An output device 824 can also be one or more of a number of output mechanisms known to those of skill in the art. In some instances, multimodal systems can enable a user to provide multiple types of input to communicate with the computing system architecture 800. The communications interface 826 can generally govern and manage the user input and system output. There is no restriction on operating on any particular hardware arrangement and therefore the basic features here may easily be substituted for improved hardware or firmware arrangements as they are developed.

Storage device 808 is a non-volatile memory and can be a hard disk or other types of computer readable media which can store data that are accessible by a computer, such as magnetic cassettes, flash memory cards, solid state memory devices, digital versatile disks, cartridges, RAMs 816, ROM 818, and hybrids thereof.

The storage device 808 can include services 810, 812, 814 for controlling the processor 804. Other hardware or software modules are contemplated. The storage device 808 can be connected to the system connection 806. In one aspect, a hardware module that performs a particular function can include the software component stored in a computer-readable medium in connection with the necessary hardware components, such as the processor 804, connection 806, output device 824, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” a set indicates that one member of the set or multiple members of the set satisfy the claim. For example, claim language reciting “at least one of A and B” means A, B, or A and B.

1. A computer-implemented method comprising:
receiving an Address Resolution Protocol (ARP) request, wherein the ARP request indicates a destination Internet Protocol (IP) address and a broadcast Media Access Control (MAC) address, and wherein the ARP request is associated with a first customer edge (CE) device;
transmitting the ARP request to a set of locally connected CE devices;
generating an IP address resolution request message, wherein when the IP address resolution request message is generated, the IP address resolution request message is transmitted to a set of remote provider edge (PE) devices;
receiving remote adjacency information associated with a second CE device, wherein the second CE device is connected to a remote PE device from the set of remote PE devices; and
transmitting an ARP reply to the first CE device, wherein the ARP reply includes a MAC address associated with the second CE device.

2. The computer-implemented method of claim 1, wherein the IP address resolution request message is transmitted through a border gateway protocol (BGP).

3. The computer-implemented method of claim 1, further comprising:
withdrawing the IP address resolution request message in response to receiving the remote adjacency information associated with the second CE device.

4. The computer-implemented method of claim 1, wherein the ARP request and the IP address resolution request message are transmitted through a gateway interface implemented on a PE device locally connected to the first CE device.

5. The computer-implemented method of claim 1, wherein the remote PE device automatically advertises the remote adjacency information in response to receiving another ARP reply associated with the second CE device.

6. The computer-implemented method of claim 1, wherein the remote PE device transmits a new ARP request to the second CE device and other CE devices connected to the remote PE device in response to receiving the IP address resolution request message, and wherein the new ARP request indicates the destination IP address.

7. The computer-implemented method of claim 1, wherein the MAC address associated with the second CE device included in the ARP reply is a proxy MAC address that obfuscates an actual MAC address of the second CE device.

8. A system, comprising:
one or more processors; and
memory storing thereon instructions that, as a result of being executed by the one or more processors, cause the system to:
receive an Address Resolution Protocol (ARP) request, wherein the ARP request indicates a destination Internet Protocol (IP) address and a broadcast Media Access Control (MAC) address, and wherein the ARP request is associated with a first customer edge (CE) device;
transmit the ARP request to a set of locally connected CE devices;
generate an IP address resolution request message, wherein when the IP address resolution request message is generated, the IP address resolution request message is transmitted to a set of remote provider edge (PE) devices;
receive remote adjacency information associated with a second CE device, wherein the second CE device is connected to a remote PE device from the set of remote PE devices; and
transmit an ARP reply to the first CE device, wherein the ARP reply includes a MAC address associated with the second CE device.

9. The system of claim 8, wherein the IP address resolution request message is transmitted through a border gateway protocol (BGP).

10. The system of claim 8, wherein the instructions further cause the system to:
withdraw the IP address resolution request message in response to receiving the remote adjacency information associated with the second CE device.

11. The system of claim 8, wherein the ARP request and the IP address resolution request message are transmitted through a gateway interface implemented on a PE device locally connected to the first CE device.

12. The system of claim 8, wherein the remote PE device automatically advertises the remote adjacency information in response to receiving another ARP reply associated with the second CE device.

13. The system of claim 8, wherein the remote PE device transmits a new ARP request to the second CE device and other CE devices connected to the remote PE device in response to receiving the IP address resolution request message, and wherein the new ARP request indicates the destination IP address.

14. The system of claim 8, wherein the MAC address associated with the second CE device included in the ARP reply is a proxy MAC address that obfuscates an actual MAC address of the second CE device.

15. A non-transitory, computer-readable storage medium storing thereon executable instructions that, as a result of being executed by one or more processors of a computer system, cause the computer system to:
receive an Address Resolution Protocol (ARP) request, wherein the ARP request indicates a destination Internet Protocol (IP) address and a broadcast Media Access Control (MAC) address, and wherein the ARP request is associated with a first customer edge (CE) device;
transmit the ARP request to a set of locally connected CE devices;
generate an IP address resolution request message, wherein when the IP address resolution request message is generated, the IP address resolution request message is transmitted to a set of remote provider edge (PE) devices;
receive remote adjacency information associated with a second CE device, wherein the second CE device is connected to a remote PE device from the set of remote PE devices; and
transmit an ARP reply to the first CE device, wherein the ARP reply includes a MAC address associated with the second CE device.

16. The non-transitory, computer-readable storage medium of claim 15, wherein the IP address resolution request message is transmitted through a border gateway protocol (BGP).

17. The non-transitory, computer-readable storage medium of claim 15, wherein the executable instructions further cause the computer system to:
withdraw the IP address resolution request message in response to receiving the remote adjacency information associated with the second CE device.

18. The non-transitory, computer-readable storage medium of claim 15, wherein the ARP request and the IP address resolution request message are transmitted through a gateway interface implemented on a PE device locally connected to the first CE device.

19. The non-transitory, computer-readable storage medium of claim 15, wherein the remote PE device automatically advertises the remote adjacency information in response to receiving another ARP reply associated with the second CE device.

20. The non-transitory, computer-readable storage medium of claim 15, wherein the remote PE device transmits a new ARP request to the second CE device and other CE devices connected to the remote PE device in response to receiving the IP address resolution request message, and wherein the new ARP request indicates the destination IP address.
